(19) United States
(12) Patent Application Publication
(10) Pub. No.: US 2003/0011711 A1
(43) Pub. Date: Jan. 16, 2003

(54) Multimedia display apparatus for simultaneously presenting multiple programs

(76) Inventor: Rong-Fuh Shyu, Hsinchu (TW)

Correspondence Address: ELLEN SEIN AYE, Fish & Richardson P.C., 225 Franklin Street, Boston, MA, 02110-2804, US

(21) Appl. No.: 10/193,359

(22) Filed: Jul. 11, 2002

(30) Foreign Application Priority Data
Jul. 13, 2001 (TW) 90211852

(51) Int. Cl. H04N 5/445; H04N 9/74; G09G 5/00

(52) U.S. Cl. 348/564; 348/563; 348/588; 345/838

(57) ABSTRACT

The present invention relates to a multimedia display apparatus simultaneously presenting multiple programs. In corporation with a video display unit of a predetermined format and an audio play unit, the multimedia display apparatus receives radio frequency (RF) signals carrying a transport stream containing multiple programs. The multimedia display apparatus of the present invention can simultaneously display multiple programs on the video display unit, or only display one program on the video display unit, depending on a selection control signal. Furthermore, auxiliary data signals in the RF signals can be selectively displayed on the video display unit and audio data signals in the RF signals can be played in the audio play unit.

### BACKGROUND OF THE INVENTION

1. Field of the Invention

The present invention relates in general to a multimedia display apparatus. In particular, the present invention relates to a multimedia display apparatus simultaneously presenting multiple programs in a digital TV apparatus.

2. Description of the Related Art

A digital TV, such as high definition television, HDTV, adopts a standard compression algorithm, such as MPEG, which transforms the high definition audio and video data into a compressed bitstream. The audio and video data are transformed into packets of a designated size during transmission to facilitate communications between the HDTV and the computer mechanism through communication apparatus. Errors occurring during data transmission are overcome using package identifiers, headers and descriptors such that the data is synchronized and expandable.

In the coming digital TV era, many evolutional applications have appeared. Theses new applications are difficult to implement using traditional analog TV technology. Among the variety of new applications, one that simultaneously presents multiple programs transported through a single data stream to a receiver is very useful. A receiver processes selected programs contained in the bitstream and simultaneously presents the programs in different windows on a common display monitor. This application allows a viewer watching a program on one channel to track the progress of another program in another channel.

### SUMMARY OF THE INVENTION

The present invention relates to a multimedia display apparatus simultaneously presenting multiple programs. In corporation with a video display unit of a predetermined format and an audio play unit, the multimedia display apparatus receives radio frequency (RF) signals carrying a transport stream containing multiple programs. The multimedia display apparatus comprises a presentation controller, a receiver, a demodulator, a decoding processor, a digital/analog (D/A) converter, and a display format encoder. The presentation controller outputs a selection control signal according to user input, while the receiver receives the RF signals carrying a transport stream containing multiple programs, converts the RF signals into intermediate frequency (IF) signals, and digitalizes the IF signals. The demodulator demodulates the digitalized signals according to a modulation algorithm. The decoding processor demultiplexes the signals output from the demodulator into a plurality of video data streams, an auxiliary data stream, and an audio data stream according to the selection control signal, decodes the respective data streams into video data sequences, an auxiliary data sequence, and an audio data sequence, and, finally, integrates the video data sequences and the auxiliary data sequence to output an integrated video data sequence. The display format encoder also converts the integrated video data sequence from a digital form to an analog form for display in the video display unit. The D/A converter converts the audio data sequence from a digital form into an analog form for display in the audio play unit.

The decoding processor comprises a transport decoder, a plurality of video decoders, an auxiliary data decoder, and an audio decoder to demultiplex and decode the demodulated signal from the demodulator into a plurality of video data sequences, an auxiliary data sequence, and an audio data sequence according to the selection control signal. A display processor in the decoding processor integrates the video data sequences and the auxiliary sequence according to the selection control signal.

### BRIEF DESCRIPTION OF THE DRAWINGS

The present invention can be more fully understood by reading the subsequent detailed description in conjunction with the examples and references made to the accompanying drawings, wherein:

FIG. 1 is a schematic diagram of the multimedia display apparatus of the present invention;

FIG. 2 shows the structure of the display processor of the present invention; and

FIGS. 3a, 3b and 3c show display methods in the embodiment of the present invention.

### DETAILED DESCRIPTION OF THE PREFERRED EMBODIMENT

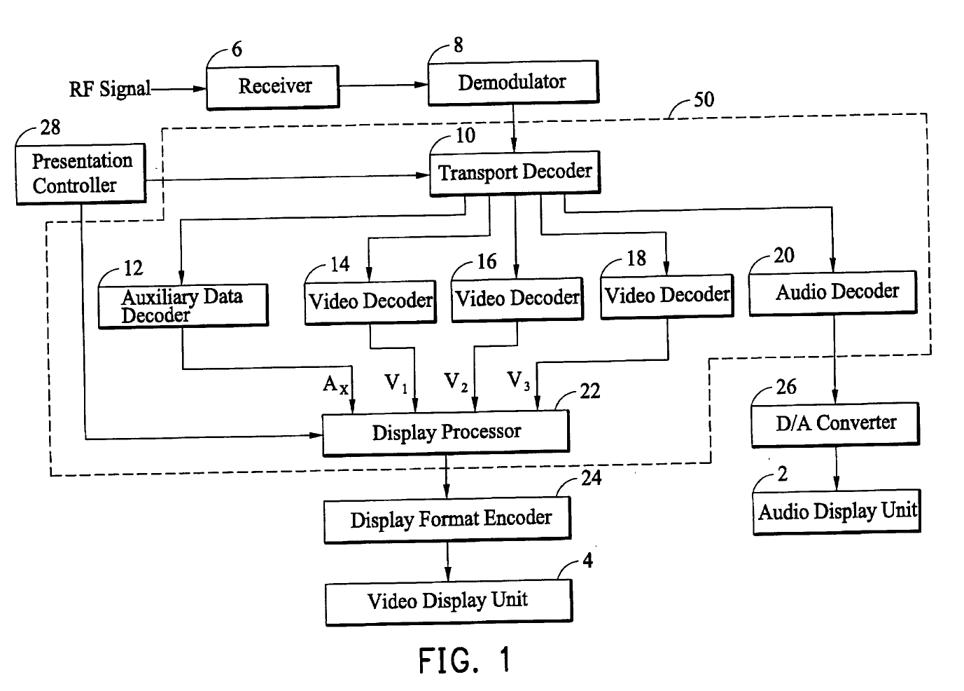

FIG. 1 is a schematic diagram of the multimedia display apparatus of the present invention. The multimedia display apparatus has a video display unit 4 and an audio play unit 2, and receives radio frequency (RF) signals carrying a transport stream containing multiple programs. The multimedia display apparatus is suitable to be used with a digital TV. As shown in FIG. 1, the multimedia display apparatus comprises a presentation controller 28, a receiver 6, a demodulator 8, a decoding processor 50, a digital/analog (D/A) converter 26, and a display format encoder 24.

The presentation controller 28 outputs selection control signals according to user input, while the receiver 6 receives the RF signals, converts the RF signals into intermediate frequency (IF) signals, and digitizes the IF signals. The demodulator 8 demodulates the digitalized signals according to a modulation algorithm. Different modulation methods are used for different transmission media. For example, VSB or COFDM (Coded Orthogonal Frequency Division Multiplex) are used for terrestrial transmission, QAM (Quadrature Amplitude Modulation) is used for cable transmission and QPSK (Quadrature Phase Shift Keying) is used for direct satellite transmission. The decoding processor 50 demultiplexes the signals output from the demodulator 8 into a plurality of video data streams, an auxiliary data stream, and an audio data stream according to the selection control signals before decoding the respective data streams into video data sequences V1,V2,V3, an auxiliary data sequence Ax, and an audio data sequence, and finally integrates the video data sequences and the auxiliary data sequence to output an integrated video data sequence. The display format encoder 24 encodes the integrated video data sequence into a predetermined format such as NTSC or PAL for traditional TV monitors and RBG for traditional computers. The display format encoder 24 also converts the encoded signal from a digital form to an analog form for displaying in the video display unit 4. The digital/analog (D/A) converter 26 converts the audio data sequence from a digital form into an analog form for display in the audio play unit 2, such as a loudspeaker.

The decoding processor 50 comprises a transport decoder 10, a plurality of video decoders 14, 16, 18, an auxiliary data decoder 12, an audio decoder 20, and a display processor 22. The transport decoder 10 receives and demultiplexes the demodulated signals from the demodulator 8 into a plurality of video data streams, an auxiliary data stream, and an audio data stream according to the selection control signal. The audio data stream can be an independent audio program or correspond to one of the video programs selected. Applying similar means, the auxiliary data stream generated by the transport decoder 10 is common service information such as motion pictures and words, or some channel-correlated information such as a channel program list or movie subtitles.

The video decoders 14,16,18, the auxiliary data decoder 12, and the audio data decoder 20 respectively decode the corresponding data streams and output video data sequences V1, V2, V3, an auxiliary data sequence Ax and an audio data sequence. The D/A converter 26 converts the audio data sequence from a digital form into an analog form played in the audio play unit 2. The output video data sequences V1, V2, V3, and the auxiliary data sequence Ax are processed in the display processor 22. The display processor 22 determines the position, the display window size and the display order of the video data sequences V1, V2, V3, and the auxiliary data sequence Ax simultaneously displayed in the display unit 4. The auxiliary data sequence is transformed in the display processor from a text form into a video form if it is selected to display on the video display unit. For example, when the program data displayed overlaps, the display processor 22 determines the background program and the overlay order of all the selected programs.

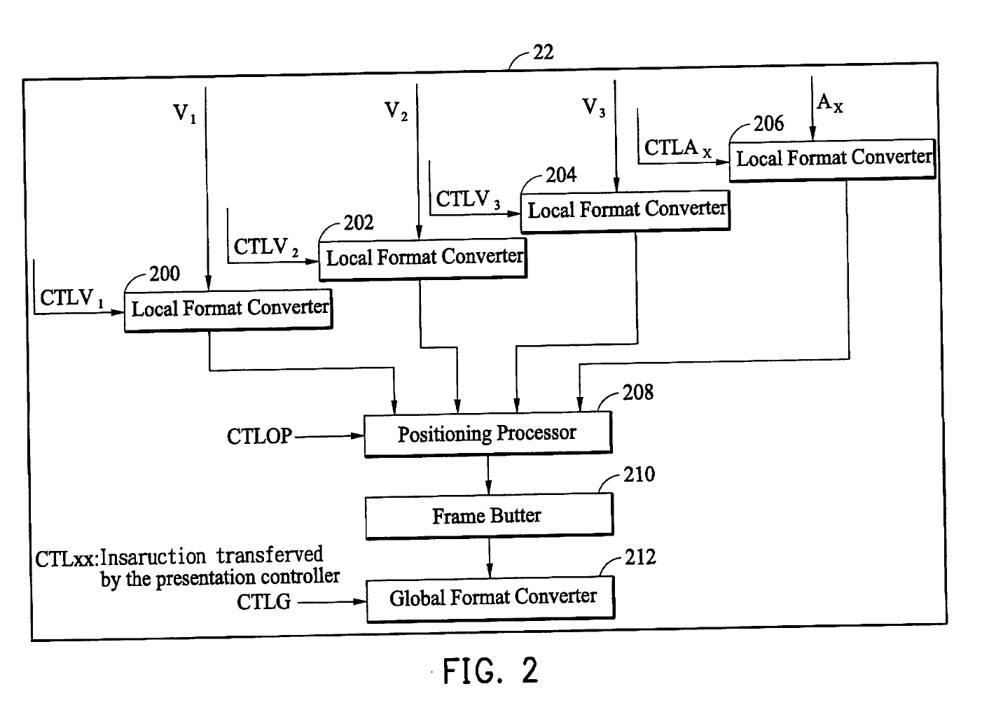

The structure of the display processor 22 is shown in FIG. 2. The display processor 22 comprises a plurality of local format converters 200, 202, 204, and 206, a positioning processor 208, a frame buffer 210, and a global format converter 212.

The local format converters 200, 202, 204, and 206, respectively format the video and auxiliary data sequences (V1, V2, V3, and Ax), such as picture scaling, rotation, and special effect enhancing, according to selection control signals CTLV1, CTLV2, CTLV3 and CTLAx from the presentation controller. Each program has a different format depending on its corresponding selection control signals (CTLV1, CTLV2, CTLV3 or CTLAx).

The positioning processor 208 integrates and determines the positioning by display priority of the formatted video and auxiliary data sequences according to the selection control signal CTLOP. Therefore, a primary video data sequence is generated. The result varies as CTLOP varies. If there is one sequence that has the high priority and intends to be displayed as a full-screen size on the video display unit, the primary video data sequence contains only the information corresponding to that sequence.

The frame buffer 210 receives and stores the primary video data sequence output from the positioning processor 208.

The global format converter 212 formats the primary video data sequence in the frame buffer 210 according to the selection control signal CTLG. The global format converter 212 is similar to local format converters 200, 202, 204 and 206 except that the global format converter 212 converts the overall integrated signals.

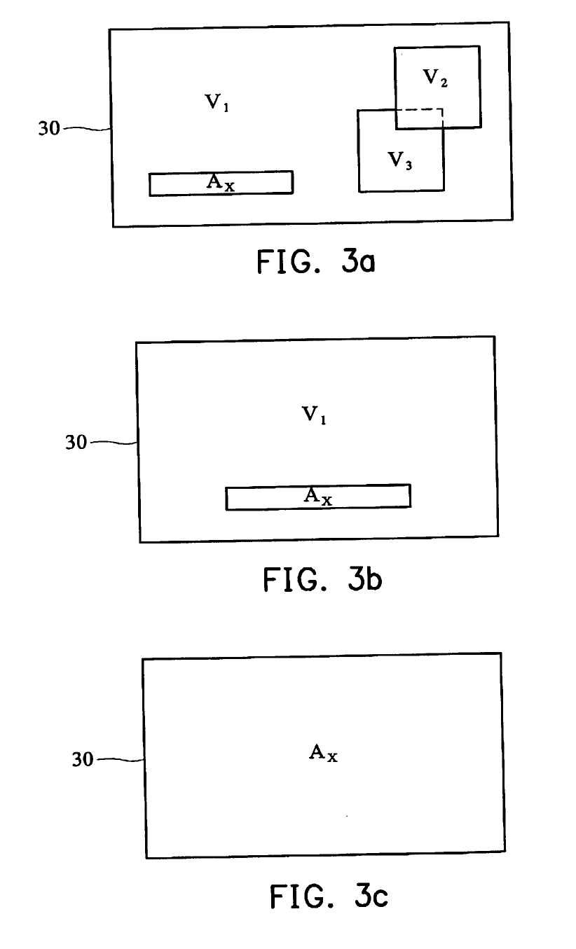

FIGS. 3a, 3b and 3c show several display methods in the embodiment of the present invention. In FIG. 3a, the video data sequences V1, V2, V3, and an auxiliary data sequence Ax are simultaneously displayed on the monitor 30 of the video display unit 4, where V2, V3 overlap with V1 as the background program, V2 has the highest overlaying priority, and the auxiliary data sequence Ax corresponds to information of the video data signals V1. In FIG. 3b, V1 is presented along with the corresponding auxiliary data sequence Ax on the monitor 30 of the video display unit 4. FIG. 3c indicates the situation in which a single video or auxiliary data is presented. In other words, to implement the application in FIG. 3c, the integrated video data sequence only contains one of the video data sequences and the auxiliary sequence.

Finally, while the invention has been described byway of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A multimedia displaying apparatus, suitable for transferring radio frequency (RF) signals carrying a transport stream into multiple programs to, capable of simultaneously displaying on a video display unit having a predetermined format and driving a audio play unit according to user input,, the multimedia display apparatus comprising:
a presentation controller, for outputting a selection control signal according to the user input;
a receiver, for converting the RF signals into intermediate frequency(IF) signals and digitalizing the IF signals;
a demodulator, for demodulating the digitalized signals output from the receiver according to a modulation algorithm to generate intermediate signals;
a decoding processor, for demultiplexing the intermediate signals into a plurality of video data streams, an auxiliary data stream, and an audio data stream according to the selection control signal, decoding the respective data streams into video data sequences, an auxiliary data sequence, and an audio data sequence and processing the video data sequences and the auxiliary data sequence into an integrated video data sequence;
a digital/analog (D/A) converter, for converting the audio data sequence from a digital form into an analog form before display; and
a display format encoder, for encoding the integrated video data sequence into the predetermined format and converting the encoded signals from a digital form into an analog form for display.

2. The multimedia display apparatus in claim 1, wherein the decoding processor comprises:
a transport decoder, for demultiplexing the demodulated signal from the demodulator into video data streams, a auxiliary data stream, and an audio data stream according to the selection control signal;
a plurality of video decoders, for decoding the video data streams into video data sequences;
an auxiliary data decoder, for decoding the auxiliary data stream into an auxiliary data sequence;
an audio decoder, for decoding the audio data stream into an audio data sequence; and
a display processor, for processing the video data sequences and the auxiliary sequence into the integrated video data sequence according to the selection control signal.

3. The multimedia display apparatus in claim 2, wherein the display processor comprises:
a plurality of local format converters, respectively formatting the video data and auxiliary data streams into formatted video data and auxiliary data sequences according to the selection control signal;
a positioning processor, for integrating the formatted video and auxiliary data sequences into a primary video data sequence according to the selection control signal;
a frame buffer, for storing the primary video data sequence received from the positioning processor; and
a global format converter, for formatting the primary video data sequence in the frame buffer according to the selection control signal.

4. A multimedia display apparatus, suitable for transferring radio frequency (RF) signals carrying a transport stream into multiple programs to, according to user input, simultaneously display on a video display unit having a predetermined format and drive a audio play unit, the multimedia display apparatus comprising:
a presentation controller, for outputting a selection control signal;
a receiver, for receiving the RF signals, converting the RF signals into intermediate (IF) signals, and digitalizing the IF signals;
a demodulator, for demodulating the digitalized signals from the receiver according to a modulation algorithm;
a transport decoder, for receiving and demultiplexing the demodulated signals from the demodulator into a plurality of video data streams, an auxiliary data stream, and an audio data stream according to the selection control signal;
a plurality of video decoders, for decoding the video data streams into video data sequences;
an auxiliary data decoder, for decoding the auxiliary data streams into an auxiliary data sequence;
an audio decoder, for decoding the audio data stream into an audio data sequence;
a display processor, for processing at least one of the sequences output by the auxiliary data decoder and the video decoders into an integrated video data sequence according to the selection control signal;
a digital/analog (D/A) converter, for converting the audio data sequence from a digital form into an analog form before presenting; and
a display format encoder, for encoding the integrated video data sequence into the predetermined format and converting the encoded signals from a digital form into an analog form for display.

5. The multimedia display apparatus in claim 4, wherein the display processor comprises:
a plurality of local format converter, respectively formatting the video data and auxiliary data streams into formatted video data and auxiliary data sequences according to the selection control signal;
a positioning processor, for integrating the formatted video and auxiliary data sequences into a primary video data sequence according to the selection control signal;
a frame buffer, for storing the primary video data sequence received from the positioning processor; and
a global format converter, for formatting the primary video data sequence in the frame buffer according to the selection control signal.

6. The multimedia display apparatus in claim 4, wherein the audio data stream is an independent audio program.

7. The multimedia display apparatus in claim 4, wherein the audio data stream corresponds to one of the video programs selected.
